(19) United States
(12) Patent Application Publication
(10) Pub. No.: US 2026/0366889 A1
(43) Pub. Date: Nov. 19, 2026

(54) INDUCTIVE POSITION MEASURING DEVICE

(71) Applicant: DR. JOHANNES HEIDENHAIN GmbH, Traunreut (DE)

(72) Inventor: Matthias ECKART, Anger (DE)

(21) Appl. No.: 19/667,785

(22) Filed: May 5, 2026

(30) Foreign Application Priority Data
May 19, 2025 (EP) 25177243.0

(51) Int. Cl. G01D 5/20

(52) U.S. Cl. CPC G01D 5/20

(57) ABSTRACT

An inductive position measuring device includes a scale element having multiple interaction surfaces and a sensor carrier having multiple first sensor elements. The sensor carrier is arranged opposite the scale element and is movable relative thereto in at least two measuring directions. Each of the first sensor elements includes a transmitting device, by which a magnetic flux can be generated in the interaction surfaces, and a receiving device having a first receiving unit and a second receiving unit, by each of which a respective change in the magnetic flux is receivable. The first sensor elements are arranged such that they form sides of a first quadrilateral, so that a first partial surface of the sensor carrier is definable. The sensor carrier includes at least one second sensor element arranged within the first partial surface.

### CROSS-REFERENCE TO RELATED APPLICATIONS

The present application claims priority to Application No. 25177243.0, filed in the European Patent Office on May 19, 2025, which is expressly incorporated herein in its entirety by reference thereto.

### FIELD OF THE APPLICATION

The present application relates to an inductive position measuring device.

### BACKGROUND INFORMATION

European Patent Document No. 4 703 673 and U.S. Patent Application Publication No. 2026/0063447 describe an inductive position measuring device that includes two assemblies that are movable relative to each other. The first assembly contains multiple linear sensors arranged to form a quadrilateral, which are capable of generating an electromagnetic field and receiving an electromagnetic field modulated by the second assembly. The second assembly includes multiple interaction surfaces arranged to form a grid on a printed circuit board substrate.

An inductive position measuring device is also described in European Patent Document No. 4 703 674 and U.S. Patent Application Publication No. 2026/0063448.

### SUMMARY

Example embodiments described in the present application provide an inductive position measuring device that is capable of determining a position with comparatively high accuracy and that is formed in a compact manner.

According to example embodiments, an inductive position measuring device includes a scale element with multiple interaction surfaces and a sensor carrier with multiple first sensor elements. The sensor carrier is arranged opposite the scale element and is movable relative thereto in at least two measuring directions. Each of the first sensor elements includes: a transmitting device through which a magnetic flux can be generated in the interaction surfaces, and a receiving device with at least one first receiving unit, through which a change in the magnetic flux is receivable.

The first sensor elements are arranged such that they form or represent sides of a first quadrilateral, so that a first quadrilateral partial surface of the sensor carrier is definable or delimitable.

The sensor carrier includes at least one second sensor element, in which the second sensor element is arranged within the first partial surface.

The first sensor elements are, for example, formed as planar linear sensors, in which each first sensor element is arranged or acts as an independently operable electronic component group. A first sensor element, via its transmitting device, can interact inductively with the interaction surfaces of the scale element and generate an electromagnetic flux in the interaction surfaces. The receiving device provides for the first sensor element to receive a change in the magnetic flux at least at certain interaction surfaces and convert it into electrical signals. The electrical signals can be used to determine at least one position value for a first sensor element and, additionally or alternatively, a distance value with respect to the relative position of the first sensor element to the scale element. For example, the first sensor elements are arranged on or in the sensor carrier. For example, the first sensor elements are formed elongated, e.g., in the shape of a rectangle. For example, at least two first sensor elements are arranged along the first measuring direction, and at least two sensor elements are arranged along the second measuring direction.

A second sensor element is arranged as an independent electronic component or an independent electronic component group and is operable independently of the first sensor elements. Using the second sensor element(s), additional and supplementary or alternatively, more precise information can be acquired by the inductive position measuring device. For example, the second sensor element is arranged as a linear sensor for acquiring position information and, additionally or alternatively, distance information. The linear sensor may, for example, be arranged as an inductive sensor, but alternative sensor principles are also possible for the second sensor elements, e.g., capacitive, magnetic or optical sensors. However, the second sensor element is not limited to a linear sensor for acquiring position information or distance information, but can alternatively also be used to acquire one or multiple physical variables (e.g. temperature, humidity, etc.).

The first sensor elements are arranged such that they form the sides of a first quadrilateral or represent the sides of a first quadrilateral, in which a first partial surface of the sensor carrier is delimitable. The individual first sensor elements do not necessarily have to contact or overlap each other to form the first quadrilateral. Rather, it is sufficient that the first sensor elements are arranged relative to each other such that the quadrilateral is also formed completely by virtually extending the first sensor elements in their longitudinal direction. The (virtual) intersection points of the inside long sides of the first sensor elements represent the corners of the first quadrilateral. For example, the quadrilateral is a rectangle, e.g., a square.

Arranging of the second sensor element within the first partial surface should be understood as meaning that the second sensor element is arranged completely, i.e., in its entirety, within the first partial surface. For example, this does not mean that the second sensor element is only partially arranged within the first quadrilateral and thereby overlaps a first sensor element or multiple first sensor elements.

According to example embodiments, at least one second sensor element is provided for the first measuring direction, at least one second sensor element is provided for the second measuring direction, and each of the second sensor elements includes: a transmitting device through which a magnetic flux can be generated in the interaction surfaces, and a receiving device, with at least one first receiving unit, through which a respective change in the magnetic flux is receivable.

According to example embodiments, the second sensor elements are arranged as planar linear sensors, in which each second sensor element is arranged or acts as an independently operable electronic component group. A second sensor element, via its transmitting device, can interact inductively with the interaction surfaces of the scale element and generate an electromagnetic flux in the interaction surfaces. The receiving device provides for a second sensor element to receive a change in the magnetic flux at certain interaction surfaces and convert it into electrical signals. The electrical signals can be used to determine at least one position value for a second sensor element and, additionally or alternatively, a distance value with respect to the relative position of the second sensor element to the scale element. For example, the second sensor elements are arranged on or in the sensor carrier. For example, the second sensor elements are formed elongated, e.g., in the shape of a rectangle.

According to example embodiments, the first receiving unit of the first sensor elements is arranged as sinusoidal receiver conductors with a first period length. The first receiving unit of the second sensor elements can also be arranged as sinusoidal receiver conductors with a second period length. For example, the second period length is smaller than the first period length.

According to example embodiments, the first sensor elements each have a second receiving unit in addition to the first receiving unit, in which the second receiving unit is identical to the first receiving unit of the first sensor elements.

According to example embodiments, the second sensor elements each have a second receiving unit in addition to the first receiving unit, in which the second receiving unit is identical to the first receiving unit of the second sensor elements.

According to example embodiments, the receiver conductors of the first or second receiving unit of the first and second sensor elements each include two coil conductors, which are each formed from multiple conductor sections, and the two coil conductors are arranged offset along the measuring direction of the corresponding first or second sensor element.

According to example embodiments, the first receiving unit has an offset relative to the second receiving unit of the first sensor elements and, additionally or alternatively, of the second sensor elements, in the direction orthogonal to the longitudinal extension of the corresponding sensor element.

According to example embodiments, at least four second sensor elements are provided, which are arranged such that they form or represent sides of a further quadrilateral, so that a further quadrilateral partial surface of the first partial surface is definable or delimitable.

For example, the first sensor elements and the second sensor elements are arranged concentrically to the center point of the sensor carrier.

According to example embodiments, the scale element includes multiple first interaction surfaces with a first width, which are arranged to form a first grid with first gaps, and multiple second interaction surfaces with a second width, which are arranged to form a second grid with second gaps.

The second width is smaller than the first width. In addition, the second gaps are smaller than the first gaps.

According to example embodiments, the following relationship applies to the first period length and the second period length:
T1=B1+L1 and T2=B2+L2,
   in which T1 represents the first period length, T2 represents the second period length, B1 represents the width of the first interaction surfaces, B2 represents the width of the second interaction surfaces, L1 represents the width of the first gaps, and L2 represents the width of the second gaps.

According to example embodiments, the following relationship applies to the dimensions of the second grid:

B_{R2}=n·B1+(n−1)·L1,

in which B_{R2} represents the dimension of the second grid in the first or second measuring direction, B1 represents the width of the first interaction surfaces, L1 represents the width of the first gaps, and n represents the interaction surface parameter with n∈ [symbol] *, [symbol] * representing the set of natural numbers that includes the positive integers excluding zero ( [symbol] *= [symbol] {0}).

For example, the second grid of second interaction surfaces are partially or completely surrounded by the first grid of first interaction surfaces.

According to example embodiments, the first sensor elements are operable by a first electronic assembly and at least one first measuring range is assigned to them, and the second sensor elements are operable by a second electronic assembly and at least one second measuring range is assigned to them.

When the position is determined by the inductive position measuring device, the first sensor elements are operated continuously, and the second sensor elements are only operated when the second grid is at least partially within the second measuring range.

According to example embodiments, the inductive position measuring device includes a third electronic assembly for alternately operating the first and second sensor elements. At least one first or second measuring range is assigned to each of the first or second sensor elements. When determining a position, on the one hand, only the first sensor elements are operated if the second grid is completely outside the second measuring range. On the other hand, only the second sensor elements are operated when the second grid is at least partially within the second measuring range.

Further features and aspects of example embodiments of the present application are described in more detail below with reference to the appended schematic Figures.

### BRIEF DESCRIPTION OF THE DRAWINGS

FIG. 1 is a perspective view of an inductive position measuring device.

FIG. 2 illustrates a sensor carrier.

FIG. 3 illustrates a first sensor element.

FIG. 4 illustrates a second sensor element.

FIG. 5 is a top view of a scale element.

FIG. 6a illustrates sensor elements arranged to form a quadrilateral.

FIG. 6b illustrates sensor elements arranged to form a quadrilateral.

FIG. 7 is a top view of a scale element.

FIG. 8 is a top view illustrating partial measuring ranges of individual sensor elements.

FIG. 9 is a top view illustrating combined measuring ranges.

FIG. 10 illustrates a measuring and evaluation device of the inductive position measuring device.

FIG. 11 illustrates a measuring and evaluation device of the inductive position measuring device.

### DETAILED DESCRIPTION

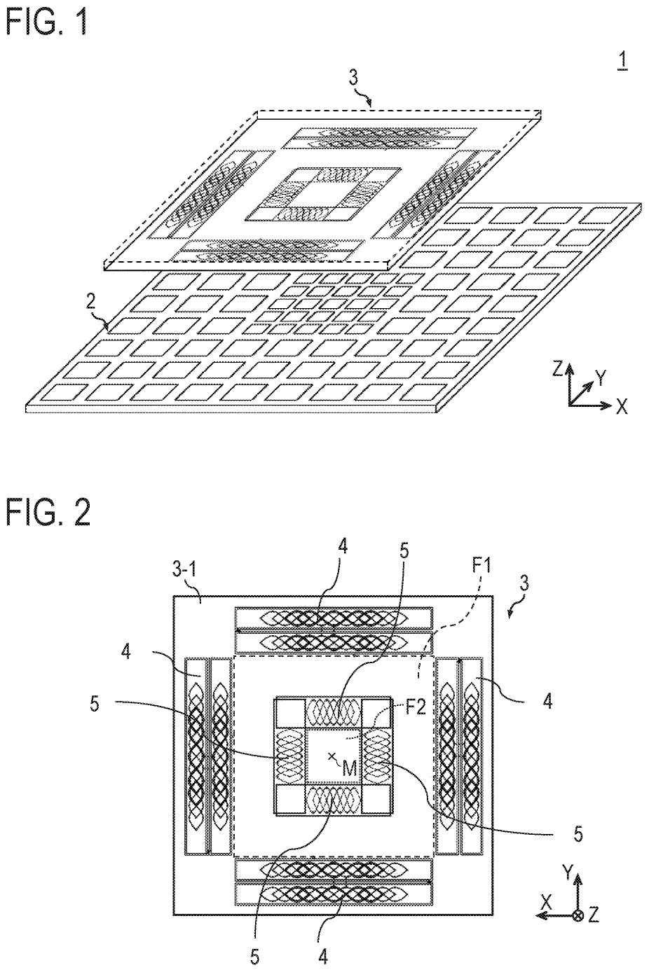

FIG. 1 is a perspective view of an inductive position measuring device that includes a sensor carrier 3 and a scale element 2. The inductive position measuring device 1 is configured, e.g., specifically designed and/or constructed, to determine the relative position of the sensor carrier 3 with respect to the scale element 2 in up to six degrees of freedom. For this purpose, the inductive position measuring device 1 uses multiple sensor elements 4, 5, which are assigned to the sensor carrier 3 and which interact inductively with interaction surfaces 7, 8 of the scale element 2. The sensor elements 4, 5 and the interaction surfaces 7, 8 are located on those sides of the scale element 2 and the sensor carrier 3 that face each other in the Z direction.

The sensor carrier 3 is arranged offset from the scale element 2 in the Z direction, so that an air gap is formed between the sensor carrier 3 and the scale element 2. The sensor carrier 3 can be moved relative to the scale element 2 at least in a first measuring direction X and in a second measuring direction Y, and it is possible to simultaneously change the distance between the sensor carrier 3 and the scale element 2, so that a relative displacement in the third measuring direction Z can also be measured and distance values and rotation values can be determined.

The scale element 2 can, for example, be arranged stationarily on a fixed object in the workspace of an industrial robot and the sensor carrier 3 can be, for example, arranged on a second object that can move in space, for example, an end effector of an industrial robot.

The inductive position measuring device 1 can determine the relative position of the end effector to the scale element 2 in all three measuring directions X, Y and Z as well as a rotation about these axes with high precision when the end effector provided with the sensor carrier 3 approaches the scale element 2.

Alternatively, it is also possible that the scale carrier 2 is arranged on the end effector of the industrial robot and that the sensor carrier 3 is stationary on a fixed object in the workspace.

FIG. 2 illustrates a sensor carrier 3 from a perspective that corresponds to the viewing direction in FIG. 1 from the scale element 2 along the Z direction to the sensor carrier 3.

The sensor carrier 3 includes a carrier substrate 3-1 made of an electrically insulating base material, for example, an epoxy resin. By a photochemical etching method, one or multiple electrically conductive layers, for example, of copper, are applied to the carrier substrate 3-1 in a structured manner, so that the first and second sensor elements 4, 5 are formed.

The sensor carrier 3 includes four first sensor elements 4, which are formed approximately rectangularly. Two first sensor elements 4 extend along the first measuring direction X, and two first sensor elements 4 extend along the second measuring direction Y. The first sensor elements 4 are arranged at a distance from each other so that a quadrilateral partial surface F1 of the sensor carrier 3 is delimited by them. For example, the first sensor elements 4 are arranged along the sides of the likewise quadrilateral carrier substrate 3-1 of the sensor carrier 3, so that the partial surface F1 is formed approximately as large as possible.

As illustrated in FIG. 2, the first sensor elements 4 can be arranged without any overlapping of the individual first sensor elements 4. According to an alternative arrangement illustrated in FIG. 6b, however, overlapping of the individual first sensor elements 4 is also possible.

Four second sensor elements 5 are arranged within the partial surface F1, which are also formed approximately rectangularly. Two second sensor elements 5 extend along the first measuring direction X, and two second sensor elements 5 extend along the second measuring direction Y. The second sensor elements 5 are also arranged at a distance from each other, so that a further quadrilateral partial surface F2 of the first partial surface F1 is delimited by the second sensor elements 5.

By arranging the second sensor elements 5 within the first partial surface F1, a particularly compact sensor carrier 3 can be achieved, which, compared to a sensor carrier 3 with only first sensor elements 4, also provides for even more measurement information and thus an even more accurate position determination.

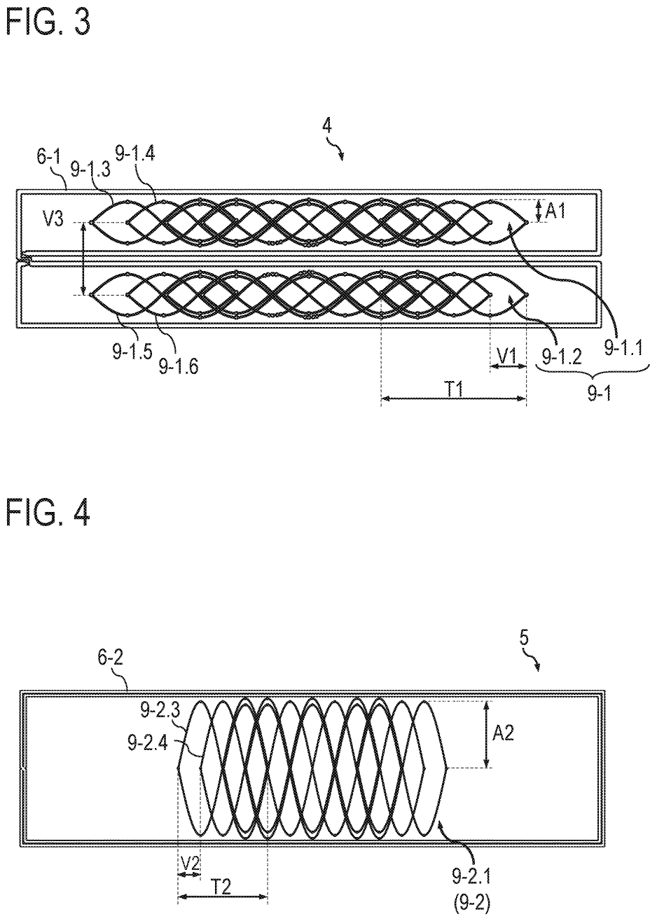

As illustrated in FIG. 3, the second sensor elements 5 can be arranged partially or alternatively completely overlapping each other.

An overlapped arrangement of the second sensor elements 5 means that at least two adjacent and orthogonal second sensor elements 5 overlap when viewed in the third measuring direction Z.

Partial overlapping means that the overlapping surface of the at least two second sensor elements 5 that are adjacent and orthogonal to each other does not correspond to the largest possible overlapping surface.

Complete overlapping means that the overlapping surface of the at least two second sensor elements 5 that are adjacent and orthogonal to each other does correspond to the largest possible overlapping surface.

The first sensor elements 4 arranged to form a first quadrilateral and the second sensor elements 5 arranged to form a second quadrilateral are positioned concentrically to the center point M of the sensor carrier 3.

An unstructured region without first or second sensor elements 4, 5 is located between the long sides of the first sensor elements 4, which are on the inside with respect to the center point M, and the long sides of the second sensor elements 5, which are on the outside with respect to the center point M. With respect to surfaces, this unstructured region corresponds to the first partial surface F1 minus the second partial surface F2 and minus the surface of the—possibly overlapped—second sensor elements 5.

For example, the second sensor elements 5 are formed smaller than the first sensor elements 4, e.g., with regard to their longitudinal extension. This ensures that the second sensor elements 5 can be accommodated within the first partial surface F1. In addition, this also ensures that the unstructured region is formed large enough so that overlapping between the first sensor elements 4 and the second interaction surfaces 8 can be avoided as far as possible when the sensor carrier 10 is deflected relative to the scale element 20, so that the highest possible signal quality is ensured.

FIG. 3 illustrates an arrangement of the first sensor elements 4. The first sensor element 4 is arranged an elongated linear sensor that includes a transmitting device 6-1 in the form of a planar conductor track, through which a magnetic flux is generated in the interaction surfaces 7, 8 of the scale element 2 in the form of eddy currents. In addition, a receiving device 9-1 is provided for receiving a change in the magnetic flux in the interaction surfaces 7. For this purpose, the receiving device 9-1 includes first and second receiving units 9-1.1, 9-1.2 including or consisting of receiver conductors in the form of planar coil conductors 9-1.3, 9-1.4, 9-1.5, 9-1.6, each having a sinusoidal curve.

The first receiving unit 9-1.1 is assigned the first and second coil conductors 9-1.3, 9-1.4, which are arranged offset from each other by a first offset V1 in the longitudinal direction of the first sensor element 4. The sinusoidal curve of the coil conductors 9-1.3, 9-1.4 of the first sensor elements 4 extends over multiple full sinusoidal periods and can be characterized by a mean first amplitude A1 and a mean first period length T1.

The first and second coil conductors 9-1.3, 9-1.4 are each formed from multiple individual conductor sections, which can be arranged in different layers of the carrier substrate 3-1, and together form the electrically conductive first or second coil conductors 9-1.3, 9-1.4. Details of such a multilayer structure including or consisting of conductor sections are described in European Patent Document No. 4 530 581 and U.S. Patent Application Publication No. 2025/0109969, each of which is expressly incorporated herein in its entirety by reference thereto.

The second receiving unit 9-1.2 includes the third and fourth coil conductors 9-1.5, 9-1.6 which are formed analogously to the first and second coil conductors 9-1.3, 9-1.4. The sinusoidal curve of the coil conductors 9-1.4, 9-1.5 of the first sensor elements 4 extends over multiple full sinusoidal periods and also has the mean first amplitude A1 and the mean first period length T1.

The first and second receiving units 9-1.1, 9-1.2 have a third offset V3 relative to each other in the direction that extends orthogonally to the longitudinal direction of the first sensor element 4.

The two receiving units 9-1.1, 9-1.2 of the first sensor element 4 are surrounded by the transmitting device 6-1, i.e., enclosed on all sides. For example, as illustrated in FIG. 3, one receiving unit 9-1.1 can be arranged within a first rectangle and the other receiving unit 9-1.2 can be arranged within the other rectangle. Alternatively, both receiving units 9-1.1, 9-1.2 can also be surrounded by the transmitting device 6-1, which has the shape of a single rectangle.

FIG. 4 shows another configuration of the second sensor elements 5. The second sensor element 5 is arranged as an elongated linear sensor that includes a transmitting device 6-2 in the form of a planar conductor track, through which a magnetic flux is generated, e.g., in the second interaction surfaces 7, 8 of the scale element 2 in the form of eddy currents. In addition, a receiving device 9-2 is provided for receiving a change in the magnetic flux, e.g., at the second interaction surfaces 8. For this purpose, the receiving device 9-2 includes a first receiving unit 9-2.1 including or consisting of receiver conductors in the form of two planar coil conductors 9-2.3, 9-2.4, each having a sinusoidal curve.

The first and second coil conductors 9-2.3, 9-2.4 are also arranged offset from each other by a second offset V2 in the longitudinal direction of the second sensor element 5. The sinusoidal curve of the coil conductors 9-2.3, 9-2.4 of the second sensor elements 5 extends over multiple full sinusoidal periods and can be characterized by a mean second amplitude A2 and a mean second period length T2.

In the second sensor elements 5, as well, the first and second coil conductors 9-2.3, 9-2.4 are each formed from multiple individual conductor sections, which can be arranged in different layers of the carrier substrate 3-1, and which together form the electrically conductive first or second coil conductors 9-2.3, 9-2.4.

The receiving unit 9-2.1, including the two coil conductors 9-2.3, 9-2.4, of the second sensor element 5 is surrounded by the transmitting device 6-2, i.e., enclosed on all sides. For example, as illustrated in FIG. 4, the transmitting device 6-2 can surround the two coil conductors 9-2.3, 9-2.4 in the form of a rectangle.

However, other configurations are also possible for the first and second sensor elements 4, 5. For example, the receiving device 9-2 of the second sensor elements 5 can also provide two receiving units and thus be formed in a similar manner to the first sensor elements 4 illustrated in FIG. 3. One such configuration is illustrated, for example, in FIG. 6b.

A further configuration for the first sensor elements 4 and additionally or alternatively second sensor elements 5 is illustrated in FIG. 6a. With an arrangement of four sensor elements 4, 5, for example, it is also possible for all four sensor elements 4, 5 to have a common transmitting device surrounding the receiving devices.

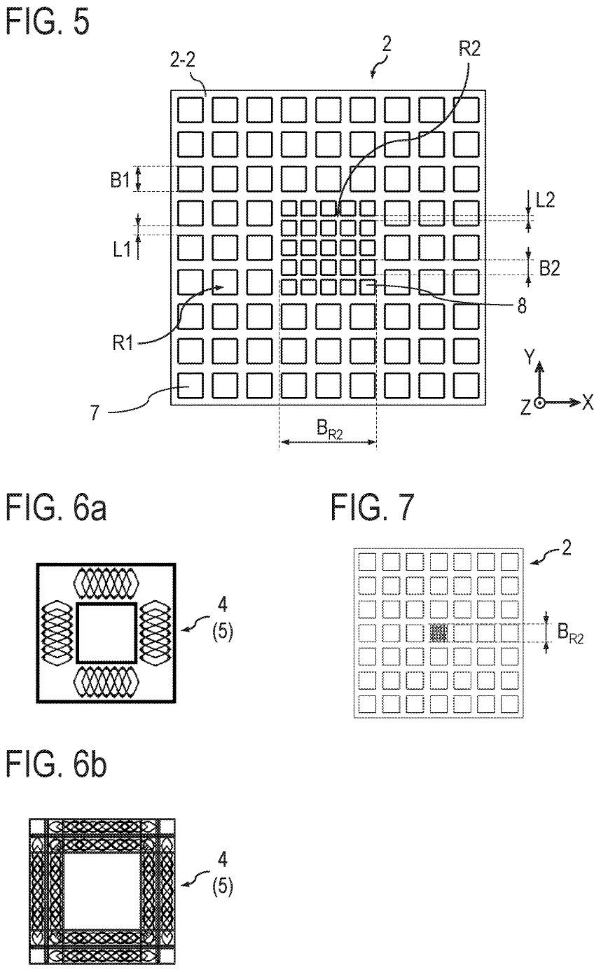

FIG. 5 illustrates a scale carrier 2, which includes a carrier substrate 2-2 and multiple first interaction surfaces 7 and multiple second interaction surfaces 8, which are each arranged to form a grid R1, R2.

The carrier substrate 2-2 can, for example, include or consist of an electrically insulating base material, such as fiber-reinforced epoxy resin, on which the individual interaction surfaces 7, 8 are formed using a photochemical etching method. In such a configuration, the interaction surfaces 7, 8 each include or consist of a thin metal layer, for example, which can interact inductively.

According to an alternative configuration of the scale carrier 2, the carrier substrate and the first and second interaction surfaces 7, 8 can also be formed from a single substrate. For example, this can be a metal substrate in which the individual interaction surfaces 7, 8 are formed in the form of elevations, for example, by a milling process. In this instance, there is no metal substrate between the individual elevated interaction surfaces and the gaps L1, L2 are present as an air gap, which can be filled with an epoxy resin, for example, so that there is a flat surface in relation to the exposed interaction surfaces 7, 8 and the gaps L1, L2 poured with resin.

The second interaction surfaces 8 are, for example, formed identically, e.g., square. The second interaction surfaces 8 are arranged in the center of the square-formed scale carrier 2 to form a second grid R2 with a regular spacing from each other. The second interaction surfaces 8 have a second width B2 and between them are the second gaps L2, which do not interact inductively, as they are either part of the carrier substrate 2-2 or formed as an air gap.

As illustrated in FIG. 5, the second grid R2 includes five rows of second interaction surfaces 8 and five columns of second interaction surfaces 8.

The second grid R2 is surrounded by multiple first interaction surfaces 7, which form a first grid R1. The first interaction surfaces 7 are also formed identically, for example, as squares as illustrated in FIG. 5. The first interaction surfaces 7 have a first width B1 and a respective distance from each one corresponding to the width of the first gaps L1.

The first grid R1 includes nine-six fully occupied and three incompletely occupied with first interaction surfaces 7-rows of first interaction surfaces 7 and nine-six fully occupied and three incompletely occupied with first interaction surfaces 7-columns of first interaction surfaces 7.

The distance between the outer second interaction surfaces 8 of the second grid R2 and the adjacent first interaction surfaces 7 of the first grid R1 corresponds to the width of the first gaps L1.

For example, the width B_{R2} of the second grid R2 is formed according to a predetermined ratio so that the second grid R2 can be implemented in the first grid R1. The width of the second grid B_{R2} is, for example, selected to satisfy the following relationship:

B_{R2}=n·B1+(n−1)·L1,

in which B_{R2} represents the dimension of the second grid R2 in the first measuring direction X or the second measuring direction Y, B1 represents the width of the first interaction surfaces 7, L1 represents the width of the first gaps, n represents interaction surface parameters with n∈ [symbol] *.

The interaction surface parameter n stands for the number of unoccupied rows or columns within the first grid R1, which are to contain the second grid R2. In the configuration illustrated in FIG. 5, n=3, which results in a width of B_{R2}=3·B1+2·L1 for the second grid R2, or in other words, the width of the second grid B_{R2} corresponds to three times the width of the first interaction surfaces 7 plus twice the width of the first gaps L1.

Based on the previously explained relationship with regard to the width B_{R2}, the second grid R2 can thus be selected in different widths as required. The selection of a larger interaction surface parameter n is beneficial, for example, if the inductive position measuring device 1 is to operate with increased accuracy within a larger measuring range MB2. If this is only necessary within a smaller measuring range or if the inductive position measuring device 1 is to provide particularly accurate measured values, a lower interaction surface parameter n can be selected. Such an alternative configuration is illustrated in FIG. 7, which illustrates a scale carrier 2 with an interaction surface parameter of n=1. In this configuration, the first grid R1 includes seven-six fully occupied and one incompletely occupied with first interaction surfaces 7-row(s) and seven-six fully occupied and one incompletely occupied with first interaction surfaces 7-column(s) of first interaction surfaces 7. The unoccupied space in the center of the first grid R1 includes the second grid R2 with a width of B_{R2}=1·B1+0·L1=B1, in which the second grid R2 includes five columns and five rows of second interaction surfaces 8.

The inductive position measuring device 1 can use the first sensor elements 4 and the second sensor elements 5 to perform a highly accurate position determination over a comparatively large measuring range, in that these interact inductively with the interaction surfaces 7, 8.

In the inductive position measuring device 1, which operates according to an incremental measuring method, the absolute position is determined within defined measuring ranges MB1, MB2, which are formed by the first or second sensor elements 3, 4.

The first sensor elements 4, arranged to form a square, each form a partial measuring range MB1.1, MB1.2, MB1.3, MB1.4, within which an absolute position determination can be carried out by the corresponding first sensor element 4. For this purpose, the first sensor elements 4 interact inductively with their transmitting devices 6-1 at least with the first interaction surfaces 7, which they overlap when viewed in the Z direction. The receiving devices 9-1 receive a change in the magnetic flux for those first interaction surfaces 7 which lie in the partial measuring range MB1.1, MB1.2, MB1.3, MB1.4 of the corresponding first sensor element 4, whereby an absolute position of the corresponding first sensor element 4 can be determined.

The partial measuring ranges MB1.1, MB1.2, MB1.3, MB1.4 of the first sensor elements 4, within which an absolute position value can be determined by the inductive position measuring device 1, have an extension in the lateral direction (XY plane) corresponding to the first period length T1 of the first sensor elements 4. The first period length T1 corresponds to the width of the first interaction surfaces B1 plus the width of the first gaps L1 (T1=B1+L1).

Similarly, the second sensor elements 5, which are also arranged to form a square within the first partial surface F1, can achieve an absolute position determination within the corresponding partial measuring ranges MB2.1, MB2.2, MB2.3, MB2.4 of the second sensor elements 5 by the inductive interaction of second sensor elements 5 with at least part of the second interaction surfaces 8. An inductive interaction means that a magnetic flux is generated by the transmitting devices 6-2 at least in the second interaction surfaces 8, which are overlapped by the corresponding second sensor elements 5 when viewed along the Z direction. The receiving devices 9-2 can subsequently receive a change in the magnetic flux with respect to the second interaction surfaces 8 within the partial measuring ranges MB2.1, MB2.2, MB2.3, MB2.4, whereby an absolute position of the corresponding second sensor elements 5 can be determined.

The partial measuring ranges MB2.1, MB2.2, MB2.3, MB2.4 of the second sensor elements 5, within which an absolute position value can be determined by the inductive position measuring device 1, have an extension in the lateral direction (XY) corresponding to the second period length T2 of the second sensor elements 5. The second period length T2 corresponds to the width of the second interaction surfaces B2 plus the width of the second gaps L2 (T2=B2+L2).

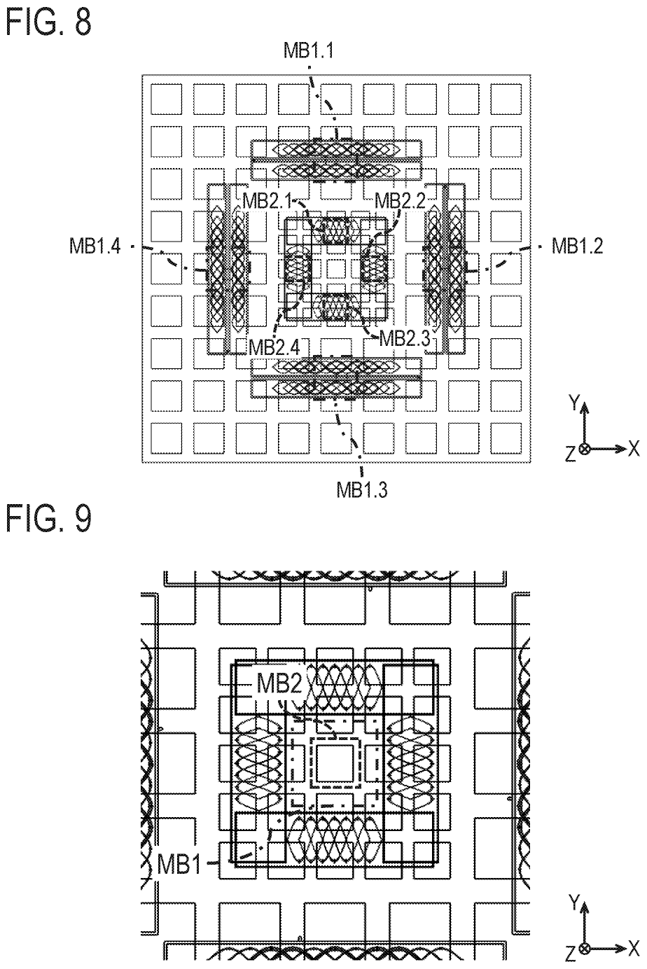

The individual partial measuring ranges MB1.1, MB1.2, MB1.3, MB1.4, MB2.1, MB2.2, MB2.3, MB2.4 have a variable extension in the distance direction Z, which is proportional to the signal period length and the period length T1, T2 of the corresponding sensor element. Consequently, for the configuration illustrated in FIG. 8, the partial measuring ranges MB1.1, MB1.2, MB1.3, MB1.4 of the first sensor elements 4 extend further in the direction of the scale element 20 with respect to the distance direction Z than the second partial measuring ranges MB2.1, MB2.2, MB2.3, MB2.4 of the second sensor elements 5.

By selectively calculating the individual partial measuring ranges MB1.1, MB1.2, MB1.3, MB1.4 of the first sensor elements 4 and the individual partial measuring ranges MB2.1, MB2.2, MB2.3, MB2.4 of the second sensor elements 5, these can each be combined to form a measuring range MB1 for all first sensor elements 4 and a measuring range MB2 for all second sensor elements 5 at the center point M of the sensor carrier 3.

Due to the smaller period length T2 of the second sensor elements 5 and the correspondingly formed second interaction surfaces 8, a high resolution can be achieved by the second sensor elements 5 within a smaller measuring range MB2. At the same time, the first sensor elements 7 provide a large measuring range MB1 within which a position determination can be carried out over a large surface.

The inductive position measuring device 1 thus includes two sensor arrangements, including the first sensor elements 4 arranged to form a quadrilateral and the second sensor elements 5 arranged to form a further quadrilateral, which are arranged one inside the other in order to combine both a large measuring range and a high resolution in one system.

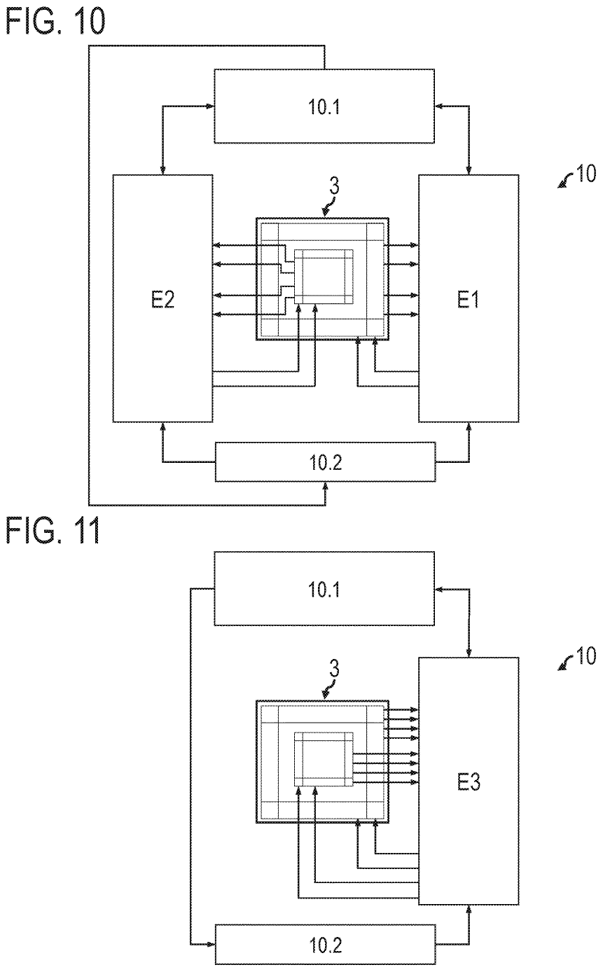

FIG. 10 illustrates a measuring and evaluation device 10 of the inductive position measuring device 1.

The measuring and evaluation device 10 includes at least one evaluation module in the form of an application-specific integrated circuit (ASIC) 10.1, a signal generator module in the form of an excitation resonant circuit 10.2, and two electronic assemblies E1, E2 for switching and controlling the sensor elements 4, 5.

The first and second electronic assemblies E1, E2 are each connected to the ASIC 10.1 and to the excitation resonant circuit 10.2. The first electronic assembly E1 ensures that the individual first sensor elements 4 are operated cyclically and alternately when determining a position. The second electronic assembly E2 ensures that the individual second sensor elements 5 are operated cyclically and alternately when determining a position. For example, those first sensor elements 4 or those second sensor elements 5 that are arranged parallel to each other and along an identical measuring direction X, Y are operated simultaneously. This means that within a measuring cycle, initially only the first sensor elements 4 or second sensor elements 5 extending in the first measuring direction X are operated. Here, the transmitting devices 6-1 or the transmitting devices 6-2 of the first sensor elements 4 or the second sensor elements 5 are temporarily connected to the excitation resonant circuit 10.2 and the receiving devices 9-1 or the receiving devices 9-2 of the first sensor elements 4 or the second sensor elements 5 are separately connected to the ASIC 10.1.

The alternating operation of the first sensor elements 4 or the second sensor elements 5 in the first and second measuring directions X, Y results in the advantage that electronic components can be reduced within the measuring and evaluation device 10. For example, this applies to the ASIC 10.1 and the excitation resonant circuit 10.2, which can be used to operate both the first sensor elements 4 and the second sensor elements 5 for both measuring directions X, Y respectively.

For example, a position determination with a measuring and evaluation device 10 according to the arrangement illustrated in FIG. 10 is carried out according to the following regulation and control logic. If the sensor carrier 3 with the second sensor arrangement, including the second sensor elements 5, is located at least partially in the region of the second interaction surfaces 8, i.e., if at least one of the second sensor elements 5 at least partially overlaps the second grid R2 in a top view in the Z direction, then, in addition to the position values and, additionally or alternatively, the distance values of the continuously operated first sensor arrangement, including the first sensor elements 4, additional high-precision position values and, additionally or alternatively, high-precision distance values, derived from the measurement information of the second sensor elements 5, can be output. Due to the smaller period length T2 of the second sensor elements 5, the measurement information has a higher resolution and is thus generally more accurate than the measurement information from the first sensor elements 4.

In summary, the measuring method of the measuring and evaluation device 10 can be described as follows. When determining the position using the inductive position measuring device 1, the first sensor elements 4 are operated continuously cyclically and alternately, regardless of which of the grids R1, R2 of the scale element 2 is overlapped by the sensor carrier 3. The second sensor elements 5 are not operated as long as they are not located above at least one second interaction surface 8 of the second grid R2. The second combined measuring range MB2 is decisive. However, it is also possible that the corresponding partial measuring ranges MB2.1, MB2.2, MB2.3, MB2.4 can be used for this purpose.

The inductive position measuring device 1 can also include an alternative configuration of the measuring and evaluation device 10, which is illustrated in FIG. 11.

In this configuration, the measuring and evaluation device 10 includes at least one evaluation module in the form of an application-specific integrated circuit (ASIC) 10.1, a signal generator module in the form of an excitation resonant circuit 10.2, but only one electronic assembly E3 for switching and controlling the sensor elements 4, 5.

The third electronic assembly E3 is connected to the ASIC 10.1 and to the excitation resonant circuit 10.2. The third electronic assembly E3 ensures that the individual first sensor elements 4 or second sensor elements 5 are operated cyclically and alternately when determining a position. For example, those first sensor elements 4 or those second sensor elements 5 which are arranged parallel to each other or along an identical measuring direction X, Y are also operated simultaneously.

When determining a position with the measuring and evaluation device 10 illustrated in FIG. 11, the following control and regulation logic is, for example, used. If the sensor carrier 3 with the second sensor arrangement including the second sensor elements 5 is located at least partially in the region of the second interaction surfaces 8, i.e., if at least one of the second sensor elements 5 at least partially overlaps the second grid R2 in a top view in the Z direction, the second sensor elements 5 are operated and the first sensor elements 4 are not operated. If the second sensor elements 5 are not (no longer) located above at least one second interaction surface 8 during a position determination, the first sensor elements 4 are operated and the second sensor elements 5 are not operated. This means that there is always just one position value and additionally or alternatively a distance value output, either on the basis of the measurement of the first sensor elements 4 or on the basis of the second sensor elements 5. This means that there is no need to operate both sensor arrangements at the same time and electronic components can be reduced for the measuring and evaluation device 10, as only one third electronic assembly E3 is required.

However, the measuring and evaluation device 10 of the inductive position measuring device 1 is not limited to the configurations illustrated in FIGS. 10 and 11. For example, instead of an ASIC 10.1 shared by the first and second sensor elements 4, 5, a first ASIC can alternatively be provided for the first sensor elements 4 and a second ASIC can be provided for the second sensor elements 5. Additionally or alternatively, instead of a shared excitation resonant circuit 10.2, a first excitation resonant circuit can be provided for the first sensor elements 4 and a second excitation resonant circuit can be provided for the second sensor elements 5.

The inductive position measuring device 1 can be used, for example, to calibrate or correct the position of the end effector of an industrial robot. The industrial robot first positions its end effector within a target range within the comparatively low accuracy of its actuators. The scale element 2 is located within the target range. Subsequently, based on the larger first measuring range MB1 of the first sensor elements 4 and the first grid R1 of the inductive position measuring device 1, a first position value is initially output and a correction of the end effector position is carried out by the industrial robot so that the second measuring range MB2 partially overlaps the second grid R2. A further high-precision position value can then be output based on the smaller second measuring range MB2 of the second sensor elements 5 and the second grid R2, on the basis of which further position value the end effector of the industrial robot can then be positioned with high precision.

### LIST OF REFERENCE CHARACTERS

1 Inductive position measuring device
2 Scale element
2-2 Carrier substrate of the scale element
3 Sensor carrier
3-1 Carrier substrate of the sensor carrier
4 First sensor element
5 Second sensor element
6-1 Transmitting device of a first sensor element
6-2 Transmitting device of a second sensor element
7 First interaction surface
8 Second interaction surface
9-1 Receiving device of a first sensor element
9-1.1 First receiving unit of a first sensor element
9-1.2 Second receiving unit of a first sensor element
9-1.3 First coil conductor of a first sensor element
9-1.4 Second coil conductor of a first sensor element
9-1.5 Third coil conductor of a first sensor element
9-1.6 Fourth coil conductor of a first sensor element
9-2 Receiving device of a second sensor element
9-2.1 First receiving unit of a second sensor element
9-2.3 First coil conductor of a second sensor element
9-2.4 Second coil conductor of a second sensor element
10 Measuring and evaluation device
10.1 ASIC
10.2 Excitation resonant circuit
M Center point
F1 First partial surface
F2 Further partial surface
T1 First period length
T2 Second period length
A1 First amplitude
A2 Second amplitude
V1 First offset
V2 Second offset
V3 Third offset
B1 First width
B2 Second width
L1 First gap
L2 Second gap
R1 First grid
R2 Second grid
n Interaction surface parameter
E1 First electronic assembly
E2 Second electronic assembly
E3 Third electronic assembly
MB1 First measuring range (first sensor element)
MB1.1 First partial measuring range (first sensor element
MB1.2 Second partial measuring range (first sensor element)
MB1.3 Third partial measuring range (first sensor element)
MB1.4 Fourth partial measuring range (first sensor element)
MB2 Second measuring range (second sensor element)
MB2.1 First partial measuring range (second sensor element)
MB2.2 Second partial measuring range (second sensor element)
MB2.3 Third partial measuring range (second sensor element)
MB2.4 Fourth partial measuring range (second sensor element)
X First measuring direction
Y Second measuring direction
Z Third measuring direction

What is claimed is:

1. An inductive position measuring device, comprising:
a scale element including multiple interaction surfaces; and
a sensor carrier arranged opposite the scale element and movable relative to the scale element in at least two measurement directions, the sensor carrier including multiple first sensor elements, each first sensor element including a transmitting device configured to generate a magnetic flux in the interaction surfaces and a receiving device, having at least one first receiving unit, configured to receive a change in the magnetic flux, the first sensor elements forming sides of a first quadrilateral to define a first partial surface of the sensor carrier, the sensor carrier including at least one second sensor element arranged within the first partial surface.

2. The inductive position measuring device according to claim 1, wherein at least one of the second sensor element is provided for a first one of the measurement directions and at least one of the second sensor element is provided for a second one of the measurement directions, each second sensor element including a transmitting device configured to generate a magnetic flux in the interaction surfaces and a receiving device, having at least one first receiving unit, configured to receive a change in the magnetic flux.

3. The inductive position measuring device according to claim 2, wherein the first receiving unit of the first sensor elements includes sinusoidal receiving conductors having a first period length, and the first receiving unit of the second sensor elements includes sinusoidal receiving conductors having a second period length smaller than the first period length.

4. The inductive position measuring device according to claim 1, wherein each of the first sensor elements includes a second receiving unit arranged identically to the first receiving unit of the first sensor elements.

5. The inductive position measuring device according to claim 2, wherein each of the second sensor elements includes a second receiving unit arranged identically to the first receiving unit of the second sensor elements.

6. The inductive position measuring device according to claim 3, wherein each of the receiving conductors of the first receiving unit or the second receiving unit of the first and second sensor elements includes two coil conductors, each coil conductor including multiple conductor sections, the two coil conductors being arranged offset along a longitudinal extension of a respective one of the first sensor element or the second sensor element.

7. The inductive position measuring device according to claim 4, wherein the first receiving unit of the first sensor elements is offset relative to the second receiving unit of the first sensor elements in a direction orthogonal to a longitudinal extension of a respective one of the first sensor elements.

8. The inductive position measuring device according to claim 5, wherein the first receiving unit of the second sensor elements is offset relative to the second receiving unit of the second sensor elements in a direction orthogonal to a longitudinal extension of a respective one of the second sensor elements.

9. The inductive position measuring device according to claim 1, wherein at least four of the second sensor elements are arranged to form sides of a second quadrilateral to define a second partial surface of the first partial surface.

10. The inductive position measuring device according to claim 9, wherein the first sensor elements and the second sensor elements are arranged concentrically to a center point of the sensor carrier.

11. The inductive position measuring device according to claim 1, wherein the interaction surfaces of the scale element include multiple first interaction surfaces having a first width and being arranged to form a first grid having first gaps, and multiple second interaction surfaces having a second width and being arranged to form a second grid having second gaps, the second width being smaller than the first width, the second gaps being smaller than the first gaps.

12. The inductive position measuring device according to claim 3, wherein the interaction surfaces of the scale element include multiple first interaction surfaces having a first width and being arranged to form a first grid having first gaps, and multiple second interaction surfaces having a second width and being arranged to form a second grid having second gaps, the second width being smaller than the first width, the second gaps being smaller than the first gaps; and
wherein the following relationships are satisfied:
T1=B1+L1 and T2=B2+L2,
T1 representing the first period length, T2 representing the second period length, B1 representing the first width of the first interaction surfaces, B2 representing the second width of the second interaction surfaces, L1 representing a width of the first gaps, L2 representing a width of the second gaps.

13. The inductive position measuring device according to claim 11, wherein the following relationship is satisfied:
B_{R2}=n·B1+(n−1)·L1,
B_{R2} representing a dimension of the second grid in the first or second measuring direction, B1 representing the first width of the first interaction surfaces, L1 representing a width of the first gaps, n representing an interaction surface parameter with n∈ [symbol] *.

14. The inductive position measuring device according to claim 11, wherein the second grid of the second interaction surfaces is partially or completely surrounded by the first grid of the first interaction surfaces.

15. The inductive position measuring device according to claim 11, wherein the first sensor elements are operable by a first electronic assembly and at least one first measuring range is assigned to the first sensor elements, the second sensor elements are operable by a second electronic assembly and at least one second measuring range is assigned to the second sensor elements, the first sensor elements being configured to operate during a position determination, the second sensor elements being configured to operate only when the second grid is at least partially within the second measuring range.

16. The inductive position measuring device according to claim 11, further comprising an electronic assembly configured to alternately operate the first sensor elements and the second sensor elements, the electronic assembly configured to operate only the first sensor elements, during a position determination, while the second grid is located outside a second measuring range assigned to the second sensor elements and configured to operate only the second sensor elements, during the position determination, while the second grid is located at least partially within the second measuring range.

17. The inductive position measuring device according to claim 1, wherein the first quadrilateral is arranged as a square.

18. The inductive position measuring device according to claim 9, wherein the second quadrilateral is arranged as a square.

19. The inductive position measuring device according to claim 1, wherein the first sensor elements do not overlap each other.

20. The inductive position measuring device according to claim 1, wherein the first sensor elements overlap each other and/or the second sensor elements overlap each other.
